(19) United States
(12) Patent Application Publication
(10) Pub. No.: US 2018/0274976 A1
(43) Pub. Date: Sep. 27, 2018

(54) ILLUMINATION DEVICE FOR SPECTRAL IMAGING

(71) Applicant: THE UNIVERSITY OF SOUTH ALABAMA, Mobile, AL (US)

(72) Inventors: Silas Leavesley, Mobile, AL (US); Thomas Rich, Mobile, AL (US)

(21) Appl. No.: 15/762,429

(22) PCT Filed: Sep. 23, 2016
(86) PCT No.: PCT/US2016/053267

§ 371 Date: Mar. 22, 2018

Related U.S. Application Data
(60) Provisional application No. 62/222,963, filed on Sep. 24, 2015.

(51) Int. Cl. G01J 3/02; G01J 3/10; G01J 3/28

(52) U.S. Cl. CPC G01J 3/021; G01J 3/2823; G01J 3/0218; G01J 3/10

(57) ABSTRACT

An illumination system incorporating a multi-faceted mirror in operative communication with an array of discrete illumination sources. The multi-faceted mirror may accept incident light beams from discrete illumination sources located at different positions and then deliver a reflected output to a common location for direct acceptance by an optical/imaging device or by a light guide transmission device operatively connected to a downstream optical/imaging device. Individual light sources may be selected and/or combined in a defined sequence by selectively activating and deactivating such light sources electronically with no need for moving parts. By pulsing different illumination sources, the optical/imaging system may be provided with a feed of narrow-band illumination for use in imaging. Outputs from several illumination sources can also be combined if desired to produce a custom-tuned illumination spectrum for a particular application.

### CROSS REFERENCE TO RELATED APPLICATIONS

This application claims the benefit of, and priority from, U.S. provisional application No. 62/222,963 having a filing date of Sep. 24, 2015. The contents of such provisional application are hereby incorporated by reference in their entirety as if fully set forth herein.

### TECHNICAL FIELD

This disclosure relates to illumination and optical devices. More particularly, this disclosure relates to a system adapted to selectively deliver the output from multiple single-band light emitting sources such as light-emitting diodes, laser diodes, and the like for supply to an operatively connected optical/imaging device such as an endoscope, microscope or the like. A common output path from discrete light sources may be produced in a manner such that a wavelength band and illumination intensity may be selected from any of the individual single-band emitting sources and/or any combination of such emitting sources. The present disclosure also relates to a method for combining outputs from multiple single-band emitting sources for delivery to an optical/imaging system.

### BACKGROUND

Reflectance and Fluorescence imaging are used in numerous medical and research applications. By way of example only, such imaging technologies have been used in fields such as endoscopy, microscopy, dermatology, ophthalmology and the like. In one environment of use, white light endoscopy (WLE) is used for colon cancer screening. However, traditional WLE relies on native tissue contrast (reflectance), and lacks substantial specificity. Autofluorescence imaging (AFI) and narrow-band imaging (NBI) have been applied in an effort to increase the ability to detect cancers of the colon. These approaches have, in some cases, shown increased sensitivity and specificity. However, specificity may still be relatively poor due to insufficient information in the one or two wavelength bands acquired. Accordingly, it is simply not possible to detect changes in the fluorescence associated with many biomarkers in the presence of autofluorescence from healthy tissue using AFI or NBI.

Studies have demonstrated that tumors and other materials for observation often have reflectance and/or fluorescence spectra that are different from surrounding tissue/materials. Sampling using a wide spectrum of wavelengths can result in increased sensitivity and/or specificity. One way to conduct such sampling is to provide illumination with multiple, discrete narrow wavelength bands over a wide spectral range.

As will be understood by those of skill in the art, fluorescence is a chemical process wherein light of a specific wavelength shined upon a fluorescent molecule causes electrons to be excited to a high energy state in a process known as excitation. These electrons remain briefly in this high energy state, for roughly a nanosecond, before dropping back to a low energy state and emitting light of a lower wavelength. This process is referred to as fluorescent emission, or alternatively as fluorescence.

In a typical fluorescence imaging application, one or more types of fluorescent materials or molecules (sometimes referred to as fluorescent dyes) are used, along with an illuminator apparatus that provides the exciting wavelength, or wavelengths. Different fluorescent molecules can be selected to have visually different emission spectra. Since different fluorescent molecules typically have different excitation wavelengths, they can be selectively excited. Therefore the excitation light should ideally have well defined bandwidths. Moreover, it may be desirable to use an intense light so as to increase the chances of the fluorescence process occurring.

Traditional fluorescence illuminators have relied on metal halide arc lamp bulbs such as Xenon or Mercury bulbs, as light sources. The broad wavelength spectrum produced by these lamps when combined with specific color or band pass filters allows for the selection of different illumination wavelengths. However, this wavelength selection and light shaping process is highly energy inefficient. In this regard, selecting only a relatively small portion of the wavelength spectrum produced by the Xenon or Mercury bulb results in the vast majority of the light output from the lamp being unused. Moreover, the wavelength selection or band pass filters are costly and can be relatively slow, especially when placed on a mechanical rotating wheel in typical multiple-wavelength applications.

When using metal halide arc lamp bulbs, the speed with which different wavelengths can be selected is limited by the mechanical motion of moving various filters into place. In addition to the sluggishness and unreliability of filter wheels, as well as energy coupling inefficiency, metal halide arc lamps are also hampered by the limited lifetime of the bulb. The intensity of the light output declines with bulb use and once exhausted, the user has to undergo a complicated and expensive process of replacing the bulb and subsequently realigning the optics without any guarantee that the illuminator will perform as before. These disadvantages make acquiring consistent results difficult and inconvenient for users who must deal with the variable output of the bulbs, and who must either be trained in optical alignment or call upon professionals when a bulb needs to be replaced.

A light-emitting diode (LED) is a solid state, semiconductor-based light source. Modern LEDs are available to provide discrete emission wavelengths ranging from ultra-violet (UV) to infrared (IR). The use of LEDs as light sources overcomes numerous limitations of metal halide arc lamps. By way of example only, the lifetime of an LED is typically rated at well over 10,000 hours which is much greater than that of metal halide arc lamps. Moreover, the power output varies negligibly over the full life of the LED. In addition, the bandwidth of the spectral output of an LED chip is typically narrow (<30 nm) which can reduce or eliminate the need for additional band pass filters in a fluorescence application. Moreover, the intensity of the output light from an LED can be quickly and accurately controlled electronically by varying the current through the LED chip(s), whereas in metal halide illuminators, the output intensity of the bulb is constant and apertures or neutral density filters are used to attenuate the light entering the microscopy.

In the past, it has been difficult to deliver the outputs from multiple discrete light sources to a common imaging device and/or to rapidly shift from one light source to another for use at such a device. Specifically, since such discrete light sources are individual units located at different positions, there has been no efficient way to operatively connect a large number of such light sources to an optical/imaging device for effective use. This has substantially limited the application of LED light sources in imaging applications to rapidly obtain multiple images at different excitation wavelengths. The difficulty of using LED light sources (and other discrete wavelength light sources) has been due to two predominant factors. First, the intensity of such discrete light sources tends to be relatively weak and there has been no convenient way to combine and align outputs from multiple sources to increase the intensity to levels desirable for some reflectance or fluorescence imaging applications. Second, even if the intensity of the light output is adequate for a particular application, there has been no convenient way to rapidly switch between outputs from different light sources with different wavelengths so as to permit rapid imagining over a wide spectral range.

Accordingly, there is a continuing need for a device and method adapted to efficiently deliver light output from multiple wide band or narrow-band illumination sources such as LEDs, lasing diodes, or the like to an optical device. By way of example only, and not limitation, such an illumination device may be used in a hyperspectral reflectance or fluorescence imaging endoscope or microscope that can reveal pathology specific changes in the structure and molecular composition of tissues, allowing early detection and differentiation of pathological processes in the colon or other tissues.

### SUMMARY OF THE DISCLOSURE

The present disclosure provides advantages and alternatives over the prior art by providing an illumination system incorporating a multi-faceted mirror in operative communication with an array of discrete illumination sources such as LEDs, lasing diodes or the like. The multi-faceted mirror may accept incident light beams from discrete illumination sources located at different positions and then deliver a reflected output to a common location for direct acceptance by an optical/imaging device or by a light guide transmission device such as a liquid light guide, fiber optic cable bundle or the like operatively connected to a downstream optical/imaging device. Individual light sources may be selected and/or combined as desired by a user by selectively activating and deactivating such light sources electronically with no need for moving parts. By pulsing the illumination sources, the optical/imaging system may be provided with a feed of narrow-band illumination for use in imaging. Outputs (i.e. wavelengths) from several illumination sources can also be combined if desired to produce a custom-tuned illumination spectrum for a particular application.

In accordance with one exemplary aspect, the present disclosure provides an illumination system adapted to supply defined wavelength light to an optical imaging device. The illumination system includes a mirror having a top and a bottom and a central axis extending between the top and the bottom. A plurality of faceted perimeter surfaces are disposed in side-by-side relation about the perimeter of the mirror. A plurality of selectively activatable, defined wavelength light sources may be arranged circumferentially about the mirror. At least a portion of the light sources are adapted to direct light emissions of discrete, defined wavelengths to opposing faceted perimeter surfaces on the mirror at an incident intensity. In this regard, the term ‘incident intensity” is intended to refer to the intensity of the raw output from a light source which is directed towards the mirror. These light emissions are reflected by the opposing faceted perimeter surfaces to produce reflected light outputs of sufficient intensity for use by the optical imaging device. The reflected light outputs from the faceted perimeter surfaces are directed to a common reflection location. The illumination system may optionally include a light guide operatively coupled to the optical imaging device. The light guide includes a light intake positioned to receive the reflected light outputs from the faceted perimeter surfaces for transmission to the optical imaging device such that upon selective activation of one or more of the light sources, reflected light from the activated light sources is supplied through the light guide to the optical imaging device. Alternatively, the reflected light outputs may be coupled directly to the input of the optical imaging device without an intermediate light guide if desired.

Other objects and advantages of the illumination device will become apparent from a description of certain exemplary embodiments thereof which are described and shown in the drawings.

### BRIEF DESCRIPTION OF THE DRAWINGS

FIG. 1 is a schematic illustration of a system consistent with the present disclosure for use in combining and aligning light outputs from multiple narrow wavelength band sources; and

FIG. 2 is a schematic illustration of a multi-faceted mirror array in the system of FIG. 1 delivering reflected light from various discrete light sources to a common location for acceptance by a light guide operatively coupled to an optical device.

Before the exemplary embodiments are illustrated and explained in detail, it is to be understood that the invention is in no way limited in its application or construction to the details and the arrangements of the components set forth in the following description or illustrated in the drawings. Rather, the invention is capable of other embodiments and of being practiced or being carried out in various ways. Also, it is to be understood that the phraseology and terminology used herein are for purposes of description only and should not be regarded as limiting. The use herein of terms such as “including” and “comprising” and variations thereof is meant to encompass the items listed thereafter and equivalents thereof as well as additional items and equivalents thereof.

### DETAILED DESCRIPTION

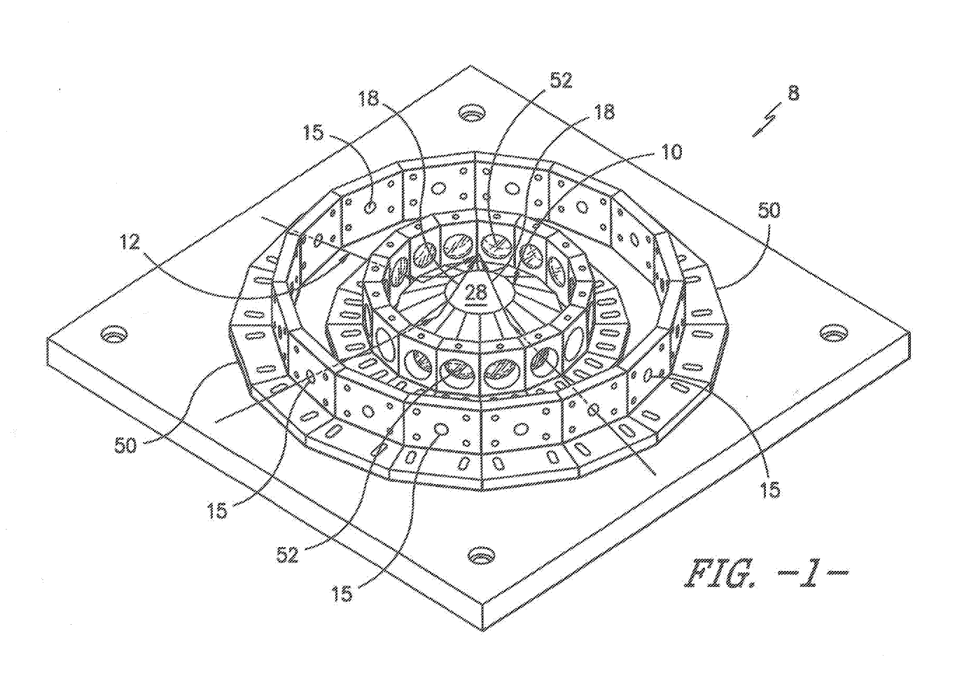

Reference will now be made to the various drawings, wherein like elements are designated by like reference numerals in the various views. FIGS. 1 and 3 schematically illustrate an exemplary illumination system 8 consistent with the present disclosure for use in collecting light outputs from multiple narrow band light sources and directing those outputs to an optical imaging device such as a microscope, endoscope or the like.

In the illustrated, exemplary system, a substantially dome-shaped mirror 10 of multi-faceted construction is used to collect and direct the light emissions 12 from multiple discrete narrow-band light sources 15. By way of example only, and not limitation, the light sources 15 may be LEDs, laser diodes or the like which may be activated individually by the selective application of current to produce light emissions 12 at defined narrow-band wavelengths. In this regard, the light sources 15 may be activated and deactivated such that a user may control which light sources 15 (or combination of light sources) are activated at any given time. In particular, such activation and deactivation may be controlled in accordance with pre-programmed instructions using a computer, a programmable logic controller or the like to provide a desired activation sequence for the light sources 15 (either individually or in combination) for a specific imagining application.

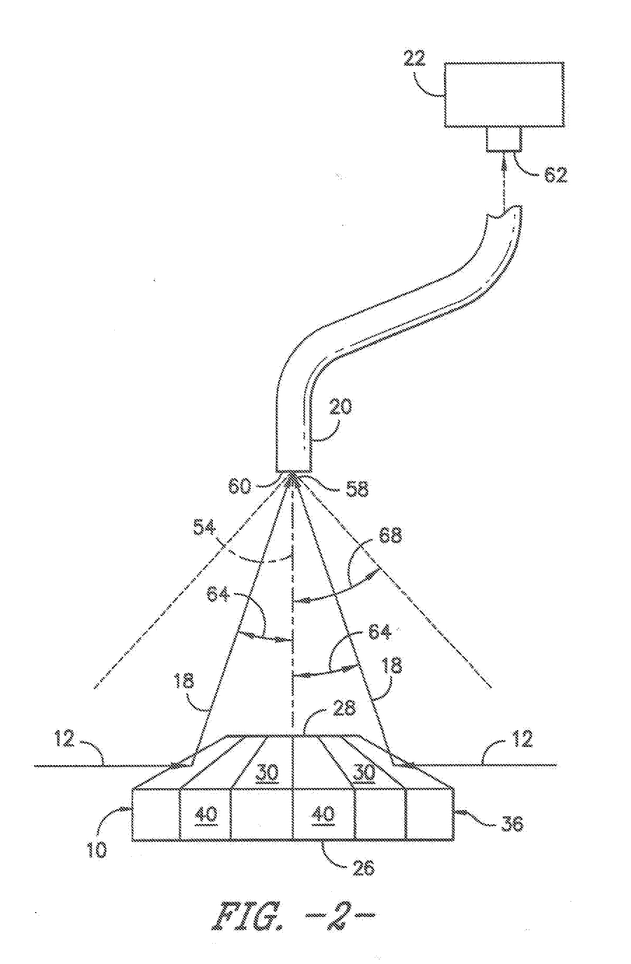

As best seen in FIG. 2, the mirror 10 receives light emissions 12 from the light sources 15 and transmits corresponding reflected light outputs 18 to a light guide 20 for transmission to an optical imagining device 22 such as a microscope, endoscope or the like which uses the supplied light for imagining functions. Alternatively, reflected light outputs 18 may be directed directly to an input for the optical imagining device 22 without an intermediate light guide 20 if desired without the necessity of altering the illumination system 8 or its function. The reflected light outputs 18 may be transmitted to the light guide 20 or imaging device 22 either individually or may be combined in groups of two or more. In this regard, the reflected light outputs 18 will correspond to the activated light sources 15 and will have the wavelengths within the bandwidth of the incident light emissions 12 from those activated light sources. That is, there is a one-to-one correspondence between the activated light sources and the reflected light outputs. If desired, an optical filter as will be well known those of skill in the art may be placed in front of one or more of the light sources 15 to narrow the bandwidth of the incident light emissions from those light sources. By way of example only, and not limitation, in the event that a light source 15 emits light with a 20 nm wavelength band, then a bypass filter may be used to narrow the wavelength of the corresponding light emission to 10 nm or less while nonetheless maintaining the same peak wavelength.

It is to be understood that the term “light guide” is intended to refer to any suitable light transmission device adapted to receive a light input for transmission to the optical imaging device 22. By way of example only, and not limitation, exemplary light guides 20 as may be used may include so called “liquid light guides” as well as fiber optic cables and the like as will be well known to those of skill in the art. Regardless of the actual construction, if a light guide 20 is used, such a light guide will preferably be characterized by highly efficient light transmission with relatively low loss of intensity between input and output. The light guide 20 will also preferably be adapted to efficiently carry light transmissions along non-linear curved guide paths so as to facilitate the remote placement of the optical device 22.

Referring now jointly to FIGS. 1 and 2, in the illustrated exemplary construction, sixteen (16) light sources 15 providing narrow band light emissions 12 may be arranged circumferentially about the multi-faceted mirror 10. Of course, a larger or smaller number of light sources may likewise be used if desired. In one exemplary embodiment, each of the light sources 15 may generate light emissions 12 of a different discrete wavelength band. However, in another exemplary embodiment, the light sources 15 may be selected such that two or more of the light sources 15 generate light emissions 12 of substantially the same wavelength band. Thus, it is contemplated that the light sources 15 may be selected to provide light emissions 12 with any number of different peak wavelengths ranging from 1 to “n” where “n” is equal to the total number of discrete light sources 15 provided.

As best seen in FIG. 2, in the illustrated exemplary construction, the mirror 10 may be substantially dome shaped generally defining a frustum with a substantially flat bottom surface 26 and a substantially flat top surface 28 oriented generally parallel to one another. Of course, any number of other constructions may likewise be used if desired. By way of example only, and not limitation, the flat top surface 28 and/or the flat bottom surface 26 may be replaced with non-flat surfaces if desired. As illustrated, in the exemplary construction, the top surface 28 is oriented in facing relation to the light guide 20 (or to the optical imaging device 22 if the light guide 20 is not used) and has a smaller diameter than the bottom surface 26. A plurality of faceted upper perimeter surfaces 30 extends in angled relation downwardly and radially away from the top surface 28. As shown, the faceted upper perimeter surfaces 30 each may be substantially trapezoidal in shape and may each have substantially equivalent dimensions to one another. Preferably, the faceted upper perimeter surfaces 30 are cooperatively arranged in direct adjacent relation to one another about the full perimeter of the mirror 10 substantially without gaps. As will be described more fully hereinafter, each of the faceted upper perimeter surfaces may define a reflection surface for an opposing narrow-band light emission 12 from a discrete light source 15 for subsequent reflective transmittal to the light guide 20 or optical imaging device 22.

In the illustrated exemplary construction, the mirror 10 may include a substantially cylindrical base portion 36 disposed between the bottom surface 26 and the faceted upper perimeter surfaces 30. As shown, a plurality of substantially rectangular or square lower perimeter surfaces 40 may be disposed about the perimeter of the base portion 36. In the illustrated exemplary construction, the lower perimeter surfaces 40 are substantially vertical and are cooperatively arranged in direct adjacent relation to one another about the full perimeter of the mirror 10 substantially without gaps. However other geometric arrangements may likewise be used if desired. As shown, each of the lower perimeter surfaces 40 may be aligned with one of the corresponding upper perimeter surfaces 30 such that a lower edge of each upper perimeter surfaces 30 also defines the upper edge of the aligned lower perimeter surfaces 40.

In accordance with one exemplary practice, it has been found that a desirable mirror 10 may be formed as a unitary coated metal structure. In particular, it has been found that a unitary structure of aluminum with a reflective overcoat provides excellent reflectance of light over a wide spectrum ranging from ultraviolet to infrared wavelengths. In this regard, while aluminum has a broad reflectance curve, it is also susceptible to oxidation. Thus, the application of a dielectric overcoat such as AlMgF₂ or the like may be desirable to promote durability.

By way of example only and not limitation, it has been found that one desirable mirror 10 may be formed by machining a block of aluminum alloy such as Al 6061 or the like to the shape as illustrated and described in relation to FIGS. 1 and 2 and thereafter applying an overcoat of AlMgF₂. In one exemplary construction such a mirror 10 was formed having a final machined diameter of 2.422 inches with a machined center thickness of 1.024 inches and a machined edge thickness (i.e the thickness of the base portion 36) of 0.630 inches. The surface finish was applied at a thickness of less than 40 Angstroms. Of course, it is to be understood that such dimensions are merely exemplary and that other suitable constructions may likewise be used if desired.

As best understood, no suitable mirror as described has been previously available on a commercial basis. However, the materials of construction are available such that suitable mirrors consistent with this disclosure may be custom machined and coated by persons of skill in the art if desired.

As best seen in FIG. 1, each light source 15 may be held in an alignment bracket 50 with its output directed radially inwardly towards a dedicated focusing lens 52. As shown, in the exemplary construction, the light sources 15 are arranged in a substantially circular pattern at substantially equal distances radially outboard from the mirror 10. Accordingly, the light sources 15 and the mirror 10 are arranged concentrically relative to one another.

During operation, light emissions of defined, discrete wavelengths are transmitted radially inwardly and through an associated focusing lens 52 in a direction substantially perpendicular to a central axis 54 of the mirror 10 (FIG. 2). As shown, the central axis 54 extends through the thickness dimension of the mirror 10 substantially perpendicular to the top surface 28 and the bottom surface 26. In this arrangement, the upper perimeter surfaces 30 are concentric relative to the central axis. After leaving the focusing lens 52, the light emission 12 from a given light source 15 intersects the mirror 10 at an opposing one of the faceted upper perimeter surfaces 30 on the mirror 10 as previously described for reflection and transmission to the light guide 20.

In accordance with one exemplary practice, the faceted upper perimeter surfaces 30 may each have a slope such that they form an acute angle in the range of about 25 degrees to about 65 degrees relative to the central axis 54. More preferably, the faceted upper perimeter surfaces 30 may each have a slope such that they form an acute angle in the range of about 40 degrees to about 50 degrees relative to the central axis 54. Most preferably, the faceted upper perimeter surfaces 30 may each have a slope such that they form an acute angle of about 45 degrees relative to the central axis 54. Of course, other angles may also be used if desired.

In the illustrated exemplary construction, the upper perimeter surfaces 30 are angled such that the light emissions from the opposing light sources 15 are reflected to converge generally at a common reflection location 58 substantially aligned with the central axis 54 at a position above the top surface 28. As best seen in FIG. 2, the common reflection location 58 corresponds generally with the position of the light intake 60 of the light guide 20. Alternatively, in the event that no light guide 20 is used, the common reflection location 58 corresponds generally with the position of a light intake 62 of the optical imaging device 22. Thus, the reflected light outputs 18 from multiple discrete light sources 15 located at diverse circumferential positions about the mirror 10 may be reflected to a common intake position for receipt by a common light guide 20 or optical imaging device 22.

In addition to being directed to a common reflection location 58, the reflected light outputs 18 exiting the mirror 10 will also preferably have a relatively steep angle of approach relative to the light intake of the light guide 20 or optical imaging device 22 so as to promote acceptance of the reflected light by the light guide 20 or optical imaging device 22. In this regard, the included angles 64 between the reflected light outputs 18 exiting the mirror 10 and the central axis 54 will preferably be substantially smaller than the acceptance angle of the opposing light guide 20 or directly coupled optical imaging device 22. In this regard, the included angle between the reflected light exiting the mirror 10 and the central axis 54 will preferably be less than about 80% of the ½ acceptance angle 68 of the light guide 20 or directly coupled optical imaging device 22, and will preferably be no more than about 50% of the ½ acceptance angle 68 of the light guide 20 or directly coupled optical imaging device 22. Such an arrangement promotes the highly efficient coupling of the reflected light outputs to a light guide 20 such as a fiber optic cable, liquid light guide or the like for subsequent transmission to an optical imaging device 22 such as a microscope, endoscope or the like where the transmitted light may be used for reflective or fluorescent imaging. Likewise, such an arrangement promotes the highly efficient coupling of the reflected light outputs directly to an optical imaging device 22 when a light guide 20 is not used.

Use of a faceted mirror 10 as described permits the highly efficient transmission of light to the common reflection location 58. In this regard, using a highly concentrated (i.e. narrow beam) light emission 12 such as from a laser diode or the like will yield a reflected light output 18 having an illumination intensity which is at least 80% of the illumination intensity of the light emission 12. As will be appreciated, if the light emission 12 is more disperse (such as from a high powered LED), less light may impact an opposing perimeter surface 30 on the mirror 10 thus reducing the percentage of the light emission that is reflected and the relative intensity of the resulting reflected light outputs. However, it has been found that using relatively high-powered LEDs driven at currents on the order of about 40 mA to 200 mA may nonetheless yield reflected optical power levels of about 5 mW to about 50 mW or greater for each wavelength band when used in conjunction with a custom-machined mirror array as shown in FIGS. 1 and 2. Such intensities are suitable for most high speed imaging applications. Moreover, in the event that additional optical power is required for a particular application, the illumination system 8 facilitates the ability to combine two or more reflected light outputs to boost intensity by simply activating multiple light sources 15 simultaneously.

An arrangement consistent with the present disclosure facilitating the selective delivery of light from multiple discrete wavelength light sources 15 to an optical imaging device 22 (either directly or through an intermediate light guide 20) provides a wide range of imaging opportunities which have heretofore been substantially impractical. In this regard, a system consistent with the present disclosure permits the delivery of light from an individual light source 15 of defined wavelength and/or from combined light sources 15 (each having a defined wavelength) by simply activating the desired light sources using manual or programmable switches as will be well understood by those of skill in the art. Moreover, simultaneous activation of two or more light sources 15 having the same wavelength may be used to increase the intensity of the delivered light thereby substantially overcoming any transmission losses due to the reflective coupling.

By way of example only, and not limitation, in one exemplary practice the individual LEDs may be selectively pulsed so as to deliver light beams of discrete wavelengths to the optical imaging device 22. As different LEDs are activated, measurements may be taken using the different wavelengths. Thus, an optical/imaging system may easily switch between wavelengths in a defined manner in carrying out image acquisition. Significantly, a system consistent with the present disclosure is not dependent upon any mechanical parts such as prior filter wheels and the like to switch between activated light sources. Rather, once the mirror 10 and light sources 15 are in place, no additional physical manipulation is required and light sources may be readily manipulated using simple programming logic suitable for the desired application.

Of course, variations and modifications of the foregoing are within the scope of the present disclosure. The use of the terms “a” and “an” and “the” and similar referents in the context of describing the invention (especially in the context of the following claims) are to be construed to cover both the singular and the plural, unless otherwise indicated herein or clearly contradicted by context.

The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An illumination system adapted to supply defined wavelength light to an optical imaging device, the illumination system comprising:
a mirror comprising a top and a bottom and a central axis extending between the top and the bottom, a plurality of faceted perimeter surfaces disposed in side-by-side relation about the perimeter of the mirror;
a plurality of selectively activatable, defined wavelength light sources disposed circumferentially about the mirror, wherein at least a portion of the light sources are adapted to direct light emissions of discrete, defined wavelengths to opposing faceted perimeter surfaces on the mirror at an incident intensity and wherein said light emissions are reflected by the opposing faceted perimeter surfaces to produce reflected light outputs having a reflected intensity of not less than about 5 mW, and wherein the reflected light outputs from the opposing faceted perimeter surfaces are directed to a common reflection location such that upon activation of one or more of the light sources, reflected light from said one or more of the light sources is supplied to the optical imaging device; and optionally
a light guide operatively coupled to the optical imaging device, the light guide having a light intake positioned to receive the reflected light outputs from the opposing faceted perimeter surfaces for transmission to the optical imaging device.

2. The illumination system as recited in claim 1, wherein the mirror is substantially dome-shaped.

3. The illumination system as recited in claim 2, wherein the mirror has a substantially flat top surface and a substantially flat bottom surface.

4. The illumination system as recited in claim 1, wherein the mirror is of unitary metal construction.

5. The illumination system as recited in claim 4, wherein the mirror is formed from a single piece of machined aluminum alloy.

6. The illumination system as recited in claim 5, wherein the mirror is coated with a coating of AlMgF₂.

7. The illumination system as recited in claim 1, wherein the faceted perimeter surfaces slope downwardly and radially away from the top surface at an angle of about 25 degrees to about 65 degrees relative to the central axis.

8. The illumination system as recited in claim 7, wherein the faceted perimeter surfaces are of substantially trapezoidal geometry.

9. The illumination system as recited in claim 1, wherein the mirror further comprises a base portion disposed between the bottom surface and the faceted perimeter surfaces, wherein the base portion comprises a plurality of substantially vertical lower perimeter surfaces of rectangular or square geometry disposed in side-by-side relation about the perimeter of the mirror in substantially aligned relation with the faceted perimeter surfaces.

10. The illumination system as recited in claim 1, wherein the light sources are selected from the group consisting of light emitting diodes and laser diodes.

11. The illumination system as recited in claim 1, wherein the light sources are oriented in substantially concentric relation to the mirror.

12. The illumination system as recited in claim 1, wherein the light guide is a liquid light guide.

13. The illumination system as recited in claim 1, wherein the light guide is a fiber optic cable.

14. An illumination system adapted to supply defined wavelength light to an optical imaging device, the illumination system comprising:
a mirror of unitary metal construction comprising a top and a bottom and a central axis extending between the top and the bottom, a plurality of faceted perimeter surfaces disposed in side-by-side relation about the perimeter of the mirror, wherein the faceted perimeter surfaces slope downwardly and radially away from the top surface at an angle of about 35 degrees to about 55 degrees relative to the central axis;
a plurality of selectively activatable, defined wavelength light sources disposed circumferentially about the mirror, wherein at least a portion of the light sources are adapted to direct light emissions of discrete, defined wavelengths to opposing faceted perimeter surfaces on the mirror at an incident intensity and wherein said light emissions are reflected by the opposing faceted perimeter surfaces to produce reflected light outputs having a reflected intensity of not less than about 5 mW, and wherein the reflected light outputs from the opposing faceted perimeter surfaces are directed to a common reflection location such that upon activation of one or more of the light sources, reflected light from said one or more of the light sources is supplied to the optical imaging device; and optionally
a light guide operatively coupled to the optical imaging device, the light guide having a light intake positioned to receive the reflected light outputs from the opposing faceted perimeter surfaces for transmission to the optical imaging device.

15. The illumination system as recited in claim 14, wherein the mirror is substantially dome-shaped.

16. The illumination system as recited in claim 15, wherein the mirror has a substantially flat top surface and a substantially flat bottom surface.

17. The illumination system as recited in claim 16, wherein the mirror is formed from a single piece of coated machined aluminum alloy.

18. The illumination system as recited in claim 17, wherein the mirror is coated with a coating of AlMgF₂.

19. The illumination system as recited in claim 17, wherein the faceted perimeter surfaces are of substantially trapezoidal geometry and wherein the mirror further comprises a base portion disposed between the bottom surface and the faceted perimeter surfaces, wherein the base portion comprises a plurality of substantially vertical lower perimeter surfaces of rectangular or square geometry disposed in side-by-side relation about the perimeter of the mirror in substantially aligned relation with the faceted perimeter surfaces.

20. An illumination system adapted to supply defined wavelength light to an optical imaging device, the illumination system comprising:
a substantially dome-shaped mirror of unitary metal construction comprising a substantially flat top surface and a substantially flat bottom surface and a central axis extending between the top surface and the bottom surface, a plurality of faceted, angled perimeter surfaces of substantially trapezoidal geometry disposed in side-by-side relation about the perimeter of the mirror, the faceted perimeter surfaces sloping downwardly and radially away from the top surface at an angle of about 25 degrees to about 65 degrees relative to the central axis, the mirror further comprising a base portion disposed between the bottom surface and the faceted perimeter surfaces, wherein the base portion comprises a plurality of substantially vertical lower perimeter surfaces of rectangular or square geometry disposed in side-by-side relation about the perimeter of the mirror in substantially aligned relation with the faceted angled perimeter surfaces, wherein the mirror is formed from a single piece of machined aluminum;
a plurality of selectively activatable, defined wavelength light emitting diodes defining light sources disposed circumferentially about the mirror in substantially concentric relation to the mirror, the light sources each being adapted to direct a light emission of discrete, defined wavelengths to an opposing faceted perimeter surface on the mirror at an incident intensity and wherein said light emission is reflected by the opposing faceted angled perimeter surface to produce a reflected light output having a reflected intensity of not less than about 5 mW, wherein the reflected light output from each of the faceted angled perimeter surfaces is directed to a common reflection location; and
a light guide operatively coupled to the optical imaging device, the light guide having a light intake positioned to receive reflected light outputs from each of the faceted perimeter surfaces for transmission to the optical imaging device such that upon activation of one or more of the light sources, reflected light from said one or more light sources is supplied to the optical imaging device.

21. A method of obtaining optical images using an optical imaging device, the method comprising the steps of:
providing a mirror comprising a plurality of faceted perimeter surfaces disposed in side-by-side relation about the perimeter of the mirror;
providing a plurality of selectively activatable, defined wavelength light sources disposed circumferentially about the mirror;
activating selected light sources individually or in combinations according to a defined activation sequence to direct light emissions of discrete, defined wavelengths from the activated light sources to opposing faceted perimeter surfaces on the mirror such that said light emissions are reflected by the opposing faceted perimeter surfaces to produce reflected light outputs having a reflected intensity of not less than about 5 mW;
directing the reflected light outputs from the opposing faceted perimeter surfaces to a common reflection location such that upon activation of one or more of the light sources, reflected light from said one or more of the light sources is supplied to the optical imaging device; and
acquiring a sequence of images at the imaging device corresponding to the activation sequence of the light sources, such that individual images within the sequence of images are acquired in conjunction with activation of corresponding defined light sources during the activation sequence.
